(19) United States
(12) Patent Application Publication
(10) Pub. No.: US 2009/0259932 A1
(43) Pub. Date: Oct. 15, 2009

(54) USER-SELECTABLE HIDE OPTION FOR A USER INTERFACE, WHICH IS NOT PERSISTED, AND WHICH IS NOT DEPENDENT UPON INTRA-DOCUMENT CONTROLS

(75) Inventors: JUDITH H. BANK, MORRISVILLE, NC (US); DIMPLE BHATIA, SAN JOSE, CA (US); LISA M.W. BRADLEY, CARY, NC (US); DANA L. PRICE, CARY, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/102,316

(22) Filed: Apr. 14, 2008

(51) Int. Cl. G06F 3/00; G06F 17/00

(52) U.S. Cl. 715/229; 715/741

(57) ABSTRACT

A stored document of a persistent data store can include digitally encoded content. A version of the stored document can be created that is placed in a non-persistent memory. This version can be referred to as a rendered document. Content from the rendered document can be presented in a user interface. A user selection of a user defined portion of the presented content can be received. Additionally, a user issued command to hide the selected portion of the presented content can be received. The rendered document can be responsively changed to omit the user defined portion of the presented content when outputting the presented content to at least one output device. The changing of the rendered document to omit the user defined portion is unable to affect the stored document in any fashion.

### BACKGROUND OF THE INVENTION

The present invention relates to the field of user interfaces, more particularly, to user-selectable hide options for a user interface that leaves a source electronic document unmodified, which is not persisted, and which is not dependent upon intra-document controls (e.g., metadata).

Presentation of digital content of an electronic document is becoming a ubiquitous and often occurring task having a myriad of forms. Electronic documents can be digitally encoded in any computer usable medium (e.g., hard drive, optical disk, flash memory device, random access memory, etc.) and can be designed to be presented to computing device (e.g., personal computers, mobile phones, email terminals, etc.) users. The presentation can be visual, as is the case with presenting electronic documents within a graphical user interface (GUI). The presentation can also be audible, such as playing automatically generated speech via a voice user interface (VUI). Other forms of presentation also exist, such as outputting an electronic document to a BRAILLE output device.

Users often desire to have only a portion of the digitally encoded content presented upon an output device. For example, a user reading text of an electronic document through a visual interface, may find a portion of the document distracting and wish to hide that portion. The distraction can be due to extraneous content (e.g., advertising, graphics, tables, extraneous text, etc.) being presented upon a limited viewing region or due to a display having limited display capabilities. For instance, many mobile devices have very small screens due to size restrictions of the mobile devices, which often results in a highly cluttered and difficult to read output. In another instance, an electronic document can include a portion that has resource intensive output characteristics, which may overload displays capabilities and/or overly task computing resources. For example, attempting to render a media object that uses shading on a portable device can produce poor results. Thus making it desirable from a user perspective to situationally omit a portion of an electronic document from an output device while presenting other document portions. These output challenges are not limited to a visual output, but also apply to printed output, to audio output, and other output modalities.

One often used means that facilitates selective content hiding involves creating sections within an electronic document using intra-document controls. These controls can be implemented as XML tags, control characters, and other metadata forms. Use of meta-data of an electronic document to assist with selective content hiding can be problematic. One simple problem relates to using automatically generated documents (e.g., PDF scanned document, speech recognized documents, etc.) that lack metadata. Another straight forward problem relates to a user having insufficient privileges against an electronic document to make changes within the document that are needed for content hiding actions. A corollary to this problem is a user saving content hiding options that are distracting to that user in subsequent situations or that are not desired by other users sharing access to the electronic document.

Traditional usages of meta-data also result in bloated (overly large) electronic documents and result in overly complex electronic documents having metadata intricacies that situationally cause occurrences of idiosyncratic behavior. No known solution provides a user with a simple mechanism to selectively omit outputted content without persisting omission specific data within the electronic document itself and/or that works independent of intra-document content hiding controls (e.g., metadata).

### BRIEF SUMMARY OF THE INVENTION

One aspect of the present invention can include a method, apparatus, computer program product, and system for interactively presenting digitally encoded content. In this aspect, digitally encoded content stored on a computing device usable medium can be identified. The digitally encoded content can be referred to as a stored document and the computing device usable medium can be a persistent data store. A version of the stored document can be created that is placed in a non-persistent memory. This version can be referred to as a rendered document. Content from the rendered document can be presented in a user interface. A user selection of a user defined portion of the presented content can be received. Additionally, a user issued command to hide the selected portion of the presented content can be received. The rendered document can be responsively changed to omit the user defined portion of the presented content when outputting the presented content to at least one output device. The changing of the rendered document to omit the user defined portion is unable to affect the stored document in any fashion. For example, other changes can occur in the rendered document, which can be saved to the stored document while content-hiding related changes are ignored.

Another aspect of the present invention can include a user interface of a computing system that includes a content hiding interface control. The control can permit a user to select a user defined portion of content of an electronic document. The control can also permit a user to apply a user selected hide option. The content hiding interface control can be configured such that selection of the user configured hide option triggers programmatic actions causing the electronic document to be presented to an output device with the defined portion of content omitted. The content hiding interface control can also be configured such that user interactions involving the content hiding interface control are unable to be persisted beyond an interactive session involving the electronic document and the user interface.

### BRIEF DESCRIPTION OF THE SEVERAL VIEWS OF THE DRAWINGS

FIG. 1 is a schematic diagram of a system for interactively hiding user defined portions of electronic document content in accordance with the inventive arrangements disclosed herein.

FIG. 2 is a flow chart of a method for hiding user defined portions of content of an electronic document while not persisting hiding related operations in accordance with an embodiment of the inventive arrangements disclosed herein.

### DETAILED DESCRIPTION OF THE INVENTION

The present invention permits a user to interactively select content of an electronic document that is to be hidden based upon an additional user selection. The selections can be made through a user interface and can cause content to be selectively omitted when presented by an output device. In one embodiment, an expandable indicator can be substituted for the omitted content, which when selected causes the content to again be presented. The invention does not require meta-data or other tags to be written to the electronic document itself. The content hiding options are not persisted beyond a current interactive session involving the interface. That is, a next time a user utilizes the interface to access the electronic document, the document will be cleared of data hiding options. In one embodiment, the electronic document can be concurrently accessed by multiple users; such that each user can selectively enable user-specific content hiding options, which have no effect on other users or upon a commonly accessed form of the shared electronic document.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

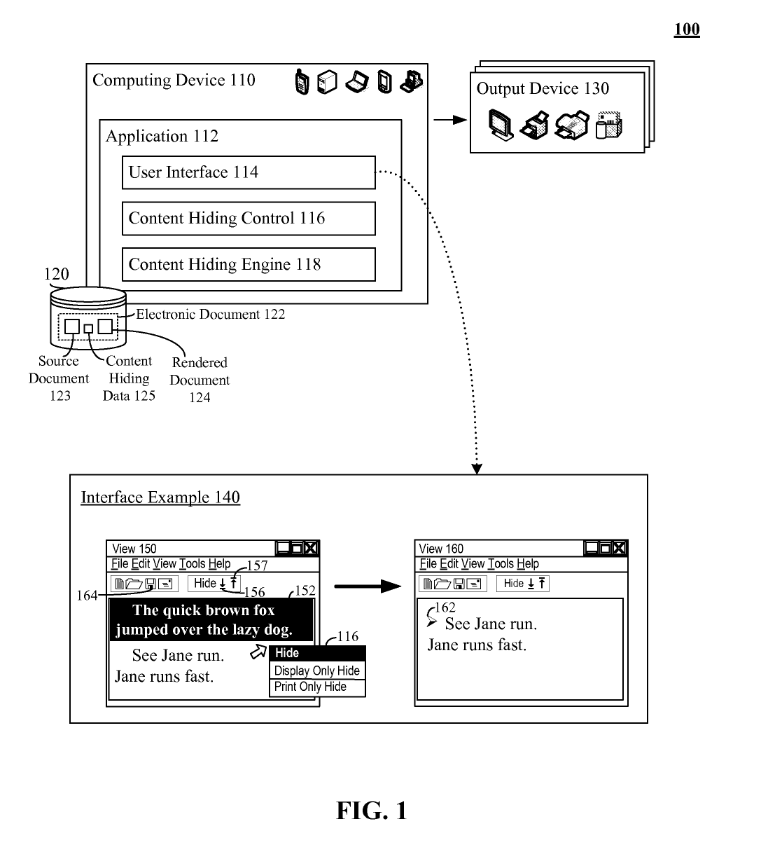

FIG. 1 is a schematic diagram of a system 100 for interactively hiding user defined portions of electronic document content in accordance with the inventive arrangements disclosed herein. System 100 includes a computing device 110 utilizing an application 112 able to load one or more electronic document 122 digitally stored in a data store 120. Interactions between application 112 and a user can occur through user interface 114. This interface 114 can include a content hiding control 116, which makes use of content hiding engine 118. Use of control 116 and engine 118 can affect a presentation of the electronic document 120 within an output device 130.

To illustrate, interface example 140 shows a view 150 and a view 160 of a user interface 114. Document 122 is loaded in each view 150, 160. In view 150, a user can select a region of content 152 and then use a content hiding control 116, which triggers one or more hiding options. For example, control 116 can specify whether specified content 152 is to be hidden in all devices 130, or whether hiding operations are to apply to only a subset of possible output devices 130, such as only applying to a printer, or a display. Selection of control 116 triggers the content hiding engine 118 to perform a programmatic action that hides the selected content, which results in view 160. In view 160, an expansion indicator 162 can replace the selected content 152 and other non-hidden content can be adjusted. A further selection of expansion indicator 162 can restore the presented content to a state shown in view 150. When content is restored or no longer hidden, the expansion indicator can optionally remain, so that another user selection of it will again result in a presentation state shown in view 160.

The content hiding of system 100 has numerous differences from conventional techniques. First, content hiding options are not retained within or even dependent upon structural controls of source document 123. A source document 123 is a persisted version of the electronic document 122, as distinguished from a rendered document 124, which is not persisted. The rendered document 124 is a version of the electronic document 122 presented in the output device 130. By default, when a save option 164 of interface 114 is selected, changes between rendered document 124 and the stored document 123 are reconciled. Changes related to content hiding control 116 and hiding engine 118 are not saved to source document 123 when a save operation (selection of save option 164) occurs.

In other words, rendered document 124 can be considered a temporary (e.g., RAM version) instance of source document 123, where content hiding specifics are not persisted. For example, when a user closes view 160 and subsequently re-loads electronic document 122 (i.e., the loading establishes an instance of source document 123 within the interface 114), no information is hidden based upon past control 116 utilizations and no expansion indicators 162 are present.

In another example, electronic document 122 can be concurrently shared by many users, where each user has a user-specific rendered document (124) version. Content hiding options relating to control 116 and engine 118 affect only one of the concurrent users. In one embodiment, application 112 can be a Web browser and the electronic document 122 can be a served HTML based document (e.g., a Web page), where users can apply user-specific hiding options to the browser rendered and interactive version (document 124) of the served Web page. Whenever browser activity occurs that causes the Web page to be reloaded content hiding options are reset.

In one embodiment, different rendered documents 124 can exist, which vary output presentation for different output devices 130. Thus, a printed version of a document (Rendered Document A) can include content with respect to content hiding options that varies from a displayed version of the document (Rendered Document B).

Additionally, in one embodiment, content hiding data 125 can be used to enumerate deltas between the source document 123 and the one or more rendered documents 124. Further, import 156 and export 157 controls can exist for interface 114 to save and retrieve content hiding data 125. This permits previously established content hiding settings to be retained beyond a session without “corrupting” the source document 123 with content hiding related metadata. Import 156 and export 157 options and use of data 125 can also permit different users to share content hiding information by sharing content hiding data 125.

Implementations are also contemplated where content hiding engine 118 includes import/export automation instructions, which can configured. For example, a user can configure an eBook reader (one device 110 that accesses electronic document 122) to automatically import a content hiding data file 125 tailored for an eBook display and configure a desktop computer (another device 110 that accesses electronic document 122) to load electronic document 122 normally, without importing file 125.

As used herein, output device 130 can be any device able to output content of application 112. For example, the output device 130 can include a monitor, a printer, a fax machine, an email system, and the like.

Computing device 110 can be any device able to execute application 112 and to present interface 114 to a user. The computing device 100 can include, but is not limited to, a personal computer, a mobile phone, a server, a tablet, an eBook reader, an embedded computing device, a kiosk, and the like.

Application 112 can include any executable computer program product having an associated user interface 114. The application 112 can load a source document 123 and interactively present a rendered document 124, whose content is selectively hideable using control 116 and engine 118. For example, application 112 can include a Web browser, a word processor, a document reader, an eBook application, a Web browser, an email application, an instant messaging application, etc.

The user interface 114 can be an interface that a user can use to interact with application 112. The user interface 114 can include a graphical user interface (GUI), a voice user interface (VUI), a multimodal interface, a text only interface, and the like.

Electronic document 122 can include any form of digitally encoded content, which is able to be presented within interface 114 and/or output to device 130. For example, the electronic document can include a Hypertext Markup Language (HTML) based document, a word processing document, an eBook, an audio Book, a PDF document, a FLASH document, a media document, a set of images, and the like.

The user content 152 can be any user selectable portion of the electronic document 122. For example, the user selectable content 152 can include text, images, and other presentable content.

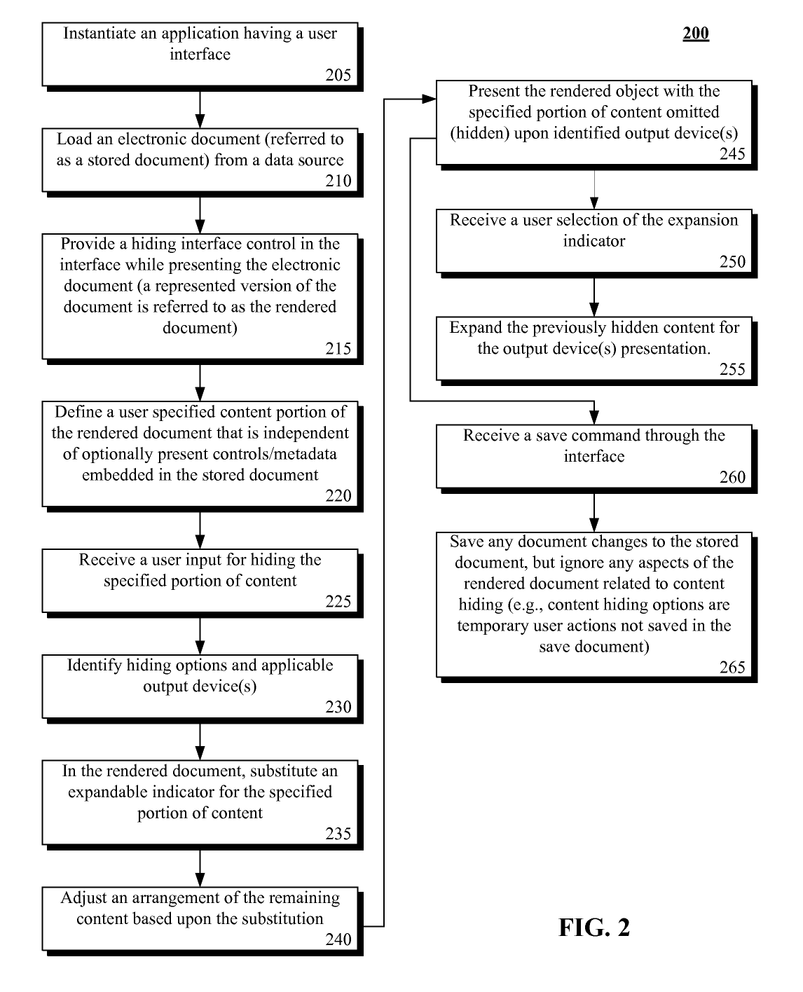

FIG. 2 is a flow chart of a method 200 for hiding user defined portions of content of an electronic document while not persisting hiding related operations in accordance with an embodiment of the inventive arrangements disclosed herein. The method 200 can be performed in context of system 100.

Method 200 can begin in step 205 where an application having a user interface can be instantiated. In step 210, an electronic document (referred to as a stored document) can be loaded from a data store. In step 215, the loaded electronic document can be presented as output of the user interface, which also includes a user selectable content hiding control. The presented version of the electronic document can be referred to as a rendered document, which can be distinct from the source document. Having a distinct software object for a rendered document is a common practice used in document editing applications, where an “in-RAM” or in-process version (rendered document) of the electronic document is one being actively edited, where the rendered document is reconciled with a stored document when a save action occurs.

In step 220, a user specified portion of the rendered document can be defined. For example, a user could highlight a portion of the rendered document within a graphical user interface using a pointing device. In step 225, a user input can be received for hiding the specified portion of content. In step 230, hiding options and/or applicable output device(s) can be identified. The output device(s) can include a visual/audio output modality associated with the user interface or any ancillary output device (e.g., printer, fax machine, email device, etc.). In step 235, in the rendered document, an expandable indicator can be substituted for the specified portion of content. In step 240, remaining content can be adjusted. In step 245, the rendered object can be presented to the identified output device(s) with the specified portion of content hidden.

Further interactions with the rendered document can subsequently occur. For example a user can select he expansion indicator (step 250), which results in the previously hidden content being expanded (step 255) so that it is no longer hidden.

In another example, a user can select a save control (step 260). This causes a reconciliation between the stored document and the rendered document. During this reconciliation, editing changes can be saved, but aspects of the rendered document related to content hiding can be ignored, as shown by step 265. That is, content hiding options are temporary options not saved in the stored document. Content hiding related data can be discarded after an interactive user session in one implementation. In another implementation, content hiding related data can be stored in a file separate from the stored document. This optional retention of the content hiding data can permit a user to import content hiding data into a loaded source document should they choose, yet typical accesses of the stored document will otherwise lack the “temporary” and session specific content hiding data.

The diagrams in FIGS. 1-2 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for interactively presenting digitally encoded content comprising:
identifying digitally encoded content stored on a persistent computing device usable medium, wherein said digitally encoded content is referred to as a stored document;
creating a version of the stored document that is placed in a non-persistent memory, wherein the version is referred to as a rendered document;
presenting content from said rendered document within a user interface;
receiving a user selection of a user defined portion of the presented content;
receiving a user command to hide the user defined portion of the presented content; and
changing the rendered document to omit the user defined portion of the presented content when outputting the presented content to at least one output device, wherein the changing of the rendered document to omit the user defined portion is unable to affect the stored document in any fashion.

2. The method of claim 1, further comprising:
substituting an expandable indicator for the omitted user defined portion the presented content, wherein the expandable indicator is a user selectable interface control, wherein a user selection of the expandable indicator changes a hide state between a state were the user defined portion of the presented content is omitted when outputting the content to the output device and a state where the user defined portion of the presented content is shown when outputting the content to the output device.

3. The method of claim 1, wherein the user defined portion is independent of metadata specified regions optionally present in the stored document.

4. The method of claim 1, wherein the user interface is an application interface, wherein the user command to hide the user defined portion comprises a user selection of an interface control of the application interface.

5. The method of claim 4, wherein the application interface comprises at least one save control, said method further comprising:
receiving a selection of the save control; and
ignoring portions of the rendered document associated with hiding the user defined portion while saving other changes made to the rendered document to the stored document.

6. The method of claim 1, wherein said stored document is a shared document, said method further comprising:
creating a plurality of rendered documents for the shared document, where each rendered document is utilized for one concurrent access of said stored document.

7. The method of claim 1, further comprising:
instantiating an application, wherein said user interface is an interface of the instantiated application;
receiving a command to load the stored document into the instantiated application;
responsive to the received command, creating the rendered document;
reflecting user interactions with the user interface immediately in the rendered document; and
discarding the rendered document when the instantiated application loads a different electronic document.

8. The method of claim 7, wherein the application is a Web browser, and wherein the stored document is a Hypertext Markup Language (HTML) based document.

9. The method of claim 1, wherein the user interface comprises a graphical user interface (GUI), and wherein the at least one output device comprises a display that presents the user interface.

10. The method of claim 1, wherein said user interface comprises a voice user interface (VUI).

11. The method of claim 1, wherein said at least one output device comprises a plurality of output devices, said method further comprising:
receiving a user selection of a set of at least one of said plurality of output devices to which the user command is to apply;
selectively omitting the user defined portion of the presented content to said set of output devices associated with the user selection.

12. The method of claim 1, wherein said at least one output device comprises a printer.

13. A computer program product for interactively presenting digitally encoded content comprising, a computer usable medium having computer usable program code embodied therewith, the computer usable program code comprising:
computer usable program code configured to identify digitally encoded content stored on a persistent computing device usable medium, wherein said digitally encoded content is referred to as a stored document;
computer usable program code configured to create a version of the stored document that is placed in a non-persistent memory, wherein the version is referred to as a rendered document;
computer usable program code configured to present content from said rendered document within a user interface;
computer usable program code configured to receive a user selection of a user defined portion of the presented content;
computer usable program code configured to receive a user command to hide the user defined portion of the presented content; and
computer usable program code configured to change the rendered document to omit the user defined portion of the presented content when outputting the presented content to at least one output device, wherein the changing of the rendered document to omit the user defined portion is unable to affect the stored document in any fashion.

14. The computer program product of claim 13, wherein the user defined portion is independent of metadata specified regions optionally present in the stored document.

15. The computer program product of claim 13, wherein the user interface is an application interface, wherein the user command to hide the user defined portion comprises a user selection of an interface control of the application interface, wherein the application interface comprises at least one save control, said computer program product further comprising:
computer usable program code configured to receive a selection of the save control; and
computer usable program code configured to ignore portions of the rendered document associated with hiding the user defined portion while saving other changes made to the rendered document to the stored document.

16. The computer program product of claim 13, further comprising:
computer usable program code configured to instantiate an application, wherein said user interface is an interface of the instantiated application;
computer usable program code configured to receive a command to load the stored document into the instantiated application;
computer usable program code configured to create the rendered document responsive to the received command;
computer usable program code configured to reflect user interactions with the user interface immediately in the rendered document; and
computer usable program code configured to discard the rendered document when the instantiated application loads a different electronic document.

17. A user interface of a computing system comprising:
a content hiding interface control configured to permit a user to select a user defined portion of content of an electronic document and configured to permit a user to apply a user selected hide option, wherein the content hiding interface control is configured such that selection of the user configured hide option triggers programmatic actions causing the electronic document to be presented to an output device with the defined portion of content omitted, wherein the content hiding interface control is configured such that user interactions involving the content hiding interface control are unable to be persisted beyond an interactive session involving the electronic document and the user interface.

18. The user interface of claim 17, wherein the user interface comprises a graphical user interface (GUI) and wherein the content hiding interface control is a graphical user interface control.

19. The user interface of claim 17, wherein the user interface comprises a voice user interface (VUI) and wherein the content hiding interface control is a voice-activated speech enabled control.

20. The user interface of claim 17, wherein said output device user selectable from a group of devices comprising at least two of a graphical display, an audio speaker, a printer, a fax machine, and an email system.
